(19) United States
(12) Patent Application Publication
(10) Pub. No.: US 2013/0221918 A1
(43) Pub. Date: Aug. 29, 2013

(54) FAST CHARGE STATIONS FOR ELECTRIC VEHICLES IN AREAS WITH LIMITED POWER AVAILABILTY

(71) Applicants: Dale Hill, Dillon, CO (US); Reuben Sarkar, Greenville, SC (US); Nicky G. Gallegos, Greenville, SC (US); Michael Alan Finnern, Greer, SC (US)

(72) Inventors: Dale Hill, Dillon, CO (US); Reuben Sarkar, Greenville, SC (US); Nicky G. Gallegos, Greenville, SC (US); Michael Alan Finnern, Greer, SC (US)

(73) Assignee: PROTERRA INC

(21) Appl. No.: 13/643,538

(22) PCT Filed: Apr. 26, 2011
(86) PCT No.: PCT/US11/33903

§ 371 Date: May 6, 2013

Related U.S. Application Data
(60) Provisional application No. 61/328,143, filed on Apr. 26, 2010.

(51) Int. Cl. B60L 11/18

(52) U.S. Cl. CPC B60L 11/185; B60L 11/1824
USPC 320/109; 320/160

(57) ABSTRACT

Systems and methods for charging a vehicle are provided. Electric or hybrid electric vehicles may be charged in areas with limited power availability or in situations where a gradual draw of power from an external energy source is desired. The external energy source may be used to charge a stationary energy storage system at a first rate, and the stationary energy storage system may be used to charge the vehicle energy storage system at a second rate. Preferably, the second rate may be greater than the first rate.

### CROSS-REFERENCE

This application claims the benefit of U.S. Provisional Application No. 61/328,143, tiled Apr. 2, 2010, which application is incorporated herein by reference in its entirety.

### BACKGROUND OF THE INVENTION

Charging stations for electric vehicles, particularly with rapid charge rates of 6 C or greater, may pose a concern when used in areas with limited power availability, such as residential or areas powered by wind or solar, or in areas where high peak demand charges apply. Current fast charge station deployments are taking place in areas with access to 12 kV high voltage transmission lines where the 440 volt, 3Ø, 1000 or more amp draw for 5-10 minutes is less problematic. Despite access to adequate power, implementation of such stations often requires considerable civil engineering and architectural involvement to integrate with the grid. However, the high current draw and civil engineering requirements make penetration into areas with lesser power availability prohibitive. In order to extend the coverage of charging stations with greater than 6 C charge rates a solution must be put in place to address the power draw and grid integration issues. Additionally, rate structures which include peak demand charges can be prohibitive from a cost perspective at 6 C rates regardless of access to high voltage transmission lines.

A need exists for improved charging stations that can oiler a fast charge to a vehicle without providing an excessive strain on an energy source, such as a utility grid.

### SUMMARY OF THE INVENTION

The invention provides systems and methods for charging electric or hybrid electric vehicles in areas with limited power availability or in situations where a gradual draw of power from an energy source is desired. Various aspects of the invention described herein may be applied to any of the particular applications set forth below or for any other types of systems or methods for charging an energy storage system. The invention may be applied as a standalone system or method, or as part of an integrated vehicle travel route. It shall be understood that different aspects of the invention can be appreciated individually, collectively, or in combination with each other.

An aspect of the invention may be directed to a fast charging station which may include a fast charging interface for electrically connecting with and charging a vehicle energy storage system. A charging station may also include a stationary energy storage system which may be electrically connected to the fast charging interface. The charging station may also include a slow charger in electrical communication with an external energy source and the stationary energy storage system. In some embodiments, the slow charger may permit a lower charge rate of the stationary energy storage system from the external energy source than the fast charging interface may permit for charging the vehicle energy storage system from the stationary energy source. In some embodiments, the external energy source may be the utility/grid.

In some embodiments, the charging station may be used in a folly buffered energy transfer process, where the vehicle energy storage system may charged via the stationary energy storage system, which is being charged by the external energy source via the slow charger. in some other embodiments, the charging station may be used in a partially buffered energy transfer process, where the vehicle energy storage system may be charged via the stationary energy storage system and the external energy source via the slow charger, where the external energy source normally charges the stationary energy storage system except when the vehicle energy storage system is being charged. In some embodiments, the charging station may have a controller which may selectively control the slow charger to permit the charging of the stationary energy storage system and/or the rate of charging the stationary energy storage system. In some instances, the controller may determine whether the external energy source is used to charge the vehicle energy storage system or the stationary energy storage system.

A method for charging an electric vehicle may be provided in accordance with another aspect of the invention. The method may include the step of electrically connecting a stationery energy storage system at a charging station with an external energy source, charging the stationery energy storage system at a first rate, electrically connecting a vehicle energy storage system on a vehicle with the stationary energy storage system, and charging the vehicle energy storage system at a second rate. Preferably, the second rate may be greater than the first rate.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE.

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a vehicle charging system in accordance with an embodiment of the invention.

FIG. 2 provides a high level depiction of an energy transfer process.

FIG. 3 shows an example of a fully buffered energy transfer process.

FIG. 4 is a block diagram of an energy transfer module,

FIG. 5 provides a high level depiction of an energy transfer process, which may be partially buffered, in accordance with an embodiment of the invention.

FIG. 6 shows an example of a partially buffered energy transfer process.

FIG. 7 shows an example of how a state of charge of a stationary energy storage system may vary over time.

FIG. 8 shows an additional example of how a state of charge of a stationary energy storage system may vary over time.

FIGS. 9A-B provides an example of a table showing an analysis during on-peak, mid-peak, and off-peak.

### DETAILED DESCRIPTION OF THE INVENTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

An aspect of the invention may involve either fully or partially buffering a fast. charge process with an upstream energy storage system connected to a slower rate charger. Instead of connecting the fast charger hardware directly to an external energy source, such as the grid, it may be connected to a stationary energy storage system. This energy storage system may in turn be connected to a slow rate charger that may plug into the grid most likely via a conventional power receptacle. Under this configuration the slower rate charger could “trickle” charge the stationary energy storage system at a rate acceptable for local power availability. The stationary energy storage system could then be used to rapidly charge a vehicle connected to a charging station at a much higher rate through a proprietary energy transfer module without adversely affecting local grid power. This may also help address high costs that can result from peak demand pricing in some regional areas. In some embodiments, the entire contents of the aforementioned process including charging station hardware and vehicle connects could be placed on a semi-portable platform which could be easily deployed. The stations could be installed into more permanent structures as well.

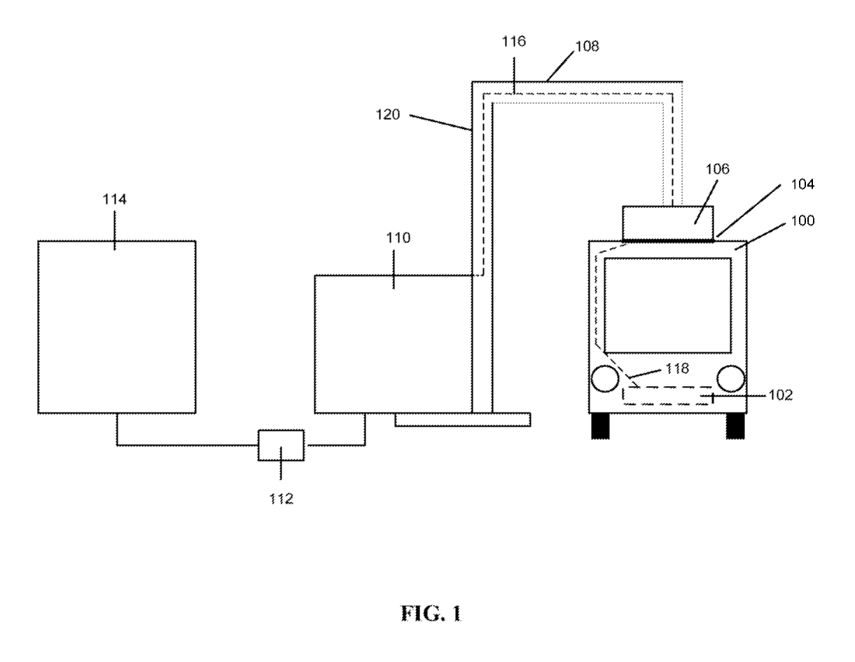

FIG. 1 shows a vehicle charging system in accordance with an embodiment of the invention. A vehicle charging system may include a charging station 120 and an external energy source 114. The charging system may also include a vehicle 100 configured to interface with the charging station.

In some embodiments, as previously mentioned, the charging station 120 may be provided on a portable, semi-portable, or permanent fixed platform. In some instances, the charging station may be movable from one location to another. In some instances, it may be easily deployed at a location, but generally remain fixed at that location. It may also be fixedly integrated into a permanent structure. One example may involve a semi-portable trailer or skid mounted fast charge station. A fast charge station may include a collapsible charge pole 108 and vehicle connector head 106, a stationary energy storage module 110, a slow charger 112 (capable of one hour recharge from the grid) and an economical energy transfer module which is in effect an electronic transfer station designed to allow the transfer of electrical energy stored in the stationary energy storage module to the vehicle energy storage module in 10 minutes or less or at greater than or equal to 6 C rates.

A C rate (1 C) may mean that a 1000 mAh battery would provide 1000 mA for one hour if discharged at 1 C rate. The same battery discharged at 0.5 C would provide 500 mA for two hours. At 2 C, the 1000 mAh battery would deliver 2000 mA for 30 minutes. 1 C is often referred to as a one-hour discharge; a 0.5 C would be a two-hour, and a 0.1 C a 10-hour discharge.
0.5 C (50 Ah)=25A for 120 minute
1 C (50 Ah)=50 A for 60 minutes
2 C (50 Ah)=100 A for 30 minutes
6 C (50 Ah)=300 A for 10 minutes

The charging station may include an electrical connector 116 between the stationary energy storage system 110 and a fast. charging interface, which may be provided on a vehicle connector head 106. The electrical connector may be formed of a conductive material, such as a metal, such as copper, aluminum, silver, gold, or any combination or alloy thereof in some instances, non-metallic conductive materials may be used. In some embodiments, the electrical connector may be formed of one or more wires, bars, plates, or any other shape or configuration,

The charging station may include a charge pole 108. The charge pole may include an overhanging arm, which may reach over a vehicle when the vehicle interfaces with the charging station. For example, a catenary arm may hang down from a protrusion over the vehicle, and extend downward and/or at an angle to the vehicle. Alternatively, the charge pole may protrude from a structure, or from a base or ground. The charge pole may enable an electrical connection to be made with the vehicle on the top of the vehicle, on a side of the vehicle, or underneath the vehicle. The charge pole may be collapsible, or be able to be unassembled for easy transport.

The charge pole 108 may be connected to a vehicle connector head 106. The vehicle connector head may provide an electrical interface for the charging station for electrically connecting with an electrical interface of the vehicle 100. As previously mentioned, the vehicle connector head may electrically interface with the vehicle, anywhere along the surface of the vehicle. The vehicle connector head and any other portion of the charging station may have a configuration that may electrically connect to a vehicle energy storage system to enable the charging and/or discharging of the vehicle energy storage system.

Examples of configurations for the charging station may include aspects, components, features, or steps provided in U.S. Patent Application Ser. No. 12/496569 filed Jul. 1, 2009 or U.S. patent application Ser. No. 61/289755 filed Dec. 23, 2009, which are hereby incorporated by reference in their entirety. For example a charging interface on the charging station may include a positive electrode and a negative electrode. The positive and negative electrodes may be electrically isolated and insulated from one another. The positive and negative electrodes may each be in electrical communication with the stationary energy storage system. One or more guiding feature may be provided on the charging station, which may enable the vehicle to drive up to the charging station and interface with the charging station. For example, a vehicle may drive beneath an overhanging catenary arm of a charging station with a fast charge electrical interface, and contact the fast charge electrical interface with an electrical interface on top of the vehicle. The structure of the charging station and/or guiding feature may include flexible components or features that may accommodate variations in vehicle size, shape, or direction of travel. The charging station may also include an interface that may ensure a solid electrical connection between electrical interface of the charging station and of the vehicle. For example, one or more pressure component, which may utilize a feature such as a spring or elastic, or an irregular surface, such as brushes, may be used to ensure contact between the charging station and the vehicle.

The charging station may include a stationary energy storage system 110. The stationary energy storage system may include one or more battery, ultracapacitor, capacitor, fuel cell, or any other way of storing energy. In some examples, the stationary energy storage may include one or more electrochemical batteries. The stationary energy storage may include batteries with any battery chemistry known in the art or later developed. Some batteries may include, but are not limited to, lead-acid (“flooded” and VRLA) batteries, NiCad batteries, nickel metal hydride batteries, lithium ion batteries, Li-ion polymer batteries, lithium titanate batteries, zinc-air batteries or molten salt batteries. The same storage units or cells may be used, or varying combinations of energy storage units or cells may be used. The energy storage units may be connected in series, or parallel, or any combination thereof. In some embodiments, groupings of energy storage units may be provided in series or in parallel, or any combination. In some implementations, stationary energy storage capacity may be within the 72-90 kWh capacity range.

In some embodiments, the stationary energy storage system may be provided within a housing of the charging station. In some embodiments, the energy storage units may all be provided within a single housing or pack, or may be distributed among multiple housings or packs. As previously mentioned, the stationary energy storage system may be electrically connected via an electrical connector 116 to a fast charging interface 106. In some embodiments, one or more groupings of energy storage units (e.g., battery cells) may be directly or indirectly connected to the fast charging interface via one or more electrical connection.

An external energy source 114 may be a utility or grid. In other embodiments, the external energy source may be an energy generator, such as any form of electricity generator. The external energy source may or may not include power sources such as power plants, or renewable energy sources such as solar power, wind power, hydropower, biofuel, or geothermal energy. In some embodiments, the external energy source may include an external energy storage system, which may include batteries, ultracapacitors, fuel cells, or so forth.

The external energy source 114 may electrically connect to a stationary energy storage system 110. in some embodiments, they may be electrically connected at an electrical interface. In preferable embodiments, the electrical interface may include a slow rate charger 112. The slow rate charger may be configured to enable control of the rate at which the stationary energy storage system is charged and/or discharged. In some embodiments, the slow rate charger or another interfacing component may enable the stationary energy storage system to plug into the external energy source in a standard manner. For example, a grid utility may be provided, and a charging station may be able to plug into a pre-existing interface with the grid utility in a standard manner. Thus, an interface of the grid utility need not be modified to accommodate a charging station.

The charging station may include a controller. The controller may be able to control the rate of charge for the stationary energy storage system from the external energy source. The controller may also permit or not permit the stationary energy storage system to be charged. In some embodiments, the controller may determine whether the stationary energy storage system is charged, discharged, or if nothing happens. The controller may be in communication with or integrated with the slow charger. In some instances, the controller may be able to detect or receive information relating to the state of charge of the stationary energy storage system. In some embodiments, a battery management system may be provided, which may function as a controller, or provide or receive instructions from a controller. Any control system may be consolidated or distributed over multiple components. Any action taken by the controller or within a vehicle charging system may be directed by tangible computer readable media, code, instructions, or logic thereof. These may be stored in a memory.

A vehicle charging system may also include a vehicle 100. Any vehicle may be able to interface with the charging station. The vehicle may be an electric or hybrid electric vehicle. In some embodiments, the vehicle may be a bus. The vehicle may also be other heavy-duty or high occupancy vehicles, wherein “heavy-duty vehicles” may include a transit bus, a school bus, a delivery van, a shuttle bus, a tractor trailer, a class 5 truck (weighing 16,001-19,500 lbs., two-axle, six-tire single unit), a class 6 truck (weighing 19,501-26,000 lbs., three-axle single unit), a class 7 truck (weighing 26.001-33,000 lbs., four or more axle single unit), a class 8 truck (weighing 33,000 lbs. and over, four or less axle single trailer), a vehicle with a GVWR weighing over 14,000 pounds, a vehicle with a cargo to driver mass ratio of 15:1 or greater, a vehicle with six or more tires, a vehicle with three or more axles, or any other type of high occupancy or heavy-duty vehicle. The vehicle may also be a regular passenger vehicle such as a passenger car, automobile, sedan, station wagon, minivan, cart, motorcycle, or scooter.

A vehicle 100 may have a vehicle energy storage system 102. The vehicle energy storage system may be used as a propulsion power source for the vehicle. The vehicle energy storage system which includes batteries. In some embodiments of the invention, the vehicle may have one or more additional power sources, such as a combustion engine or a fuel cell. The vehicle may be an electric battery-powered vehicle or a hybrid electric vehicle, and may be able to use the same basic battery configuration, drive motor, and controller, regardless of whether the vehicle is an all-battery vehicle or a hybrid vehicle.

In one embodiment of the invention, the vehicle energy storage system may include lithium titanate batteries. In some implementations, the propulsion power source may include batteries that are only lithium titanate batteries, without requiring any other types of batteries. The lithium titanate batteries may include any format or composition known in the art. See, e.g., U.S. Patent Publication No 2007/0284159, U.S. Patent Publication No. 2005/0132562, U.S. Patent Publication No. 2005/0214466, U.S. Pat. No 6,890,510, U.S. Pat. No. 6,974,566, and U.S. Pat. No. 6,881,393, which are hereby incorporated by reference in their entirety.

In accordance with another embodiment of the invention, the vehicle energy storage system may include batteries with any battery chemistry known in the art or later developed. Such electric or hybrid electric vehicle batteries may include, but are not limited to, lead-acid (“flooded” and VRLA) batteries, NiCad batteries, nickel metal hydride batteries, lithium ion batteries, Li-ion polymer batteries, zinc-air batteries or molten salt batteries. In some implementations, battery storage capacity may be within the 18 to 100 kWh capacity range.

In some alternate embodiments, the vehicle energy storage systems may include a combination of lithium titanate batteries and other types of batteries or ultra capacitors.

The use of lithium titanate batteries may enable rapid charging of a vehicle, and a long battery life. In some embodiments of the invention a vehicle energy storage system may be able to charge to a very high state of charge within minutes. For instance, in a preferable embodiment, vehicle energy storage system may be able to charge to over 95% state of charge within ten minutes. In other embodiments of the invention, a vehicle energy storage system may be able to charge to over 65% state of charge, over 70% state of charge, over 75% state of charge, over 80% state of charge, over 85% state of charge, over 90% state of charge, or over 95% state of charge within ten minutes, or nine minutes, seven minutes, five minutes, three minutes, or one minute.

In some embodiments, a vehicle, such as a heavy-duty vehicle, may travel a predetermined route, and stop at predetermined points for recharging. See, e.g., U.S. Pat. No. 3,955,657, which is hereby incorporated by reference in its entirety.

The vehicle 100 may have a vehicle charging interface 104 which may be capable of making electrical contact with the charging station 120. The vehicle charging interface may include a conductive material, which may include any of the conductive materials discussed elsewhere herein. In some embodiments, the vehicle charging interface may be provided at the top of the vehicle, while in other embodiments, it may be provided on a side or bottom of the vehicle. The vehicle charging interface may be electrically connected to a vehicle energy storage system 102. They may be connected via an electrical connection 118 of the vehicle. The electrical connector 118 may be formed of a conductive material. In some embodiments, the vehicle charging interface may include a positive and negative electrode. In some embodiments, the electrical connection 118 may include separate electrical connectors for the positive and negative electrodes to the vehicle energy storage system 102. The positive and negative electrodes may be electrically insulated and/or isolated from one another.

The vehicle charging interface 104 may electrically contact a vehicle connector head with a fast charging interface 106. This may enable the stationary energy storage system 110 to be electrically connected to the vehicle energy storage system 102. They may be electrically connected via a fast charging interface. The fast charging interface may enable control over the rate of charge and/or discharge of the vehicle energy storage system by the stationary energy storage system. In some embodiments, a controller may be provided on the charging station or on the vehicle that may control the rate of charge and/or discharge of the vehicle energy storage system. The controller may also permit or not permit charging of the vehicle energy storage system. In some embodiments, the controller may determine whether the vehicle energy storage system is charged, discharged, or if nothing happens.

A vehicle may approach a charging station and come into contact with the charging station to establish the fast charge electrical interface. When the vehicle comes into contact with the charging station, a vehicle energy storage on the vehicle may be charged by a stationary energy storage system of the charging station, or anywhere upstream of the fast charge electrical interface. The stationary energy storage system may be electrically connected to an external energy source via a slow charger. In some embodiments, the stationary energy storage system may remain in electrical communication with the external energy source. Alternatively, it may or may not be disconnected from the external energy source.

In some embodiments, multiple stationary energy storage systems may be provided. These stationary energy storage systems may be provided in series, in parallel, or in any combination thereof. Each of the stationary energy storage systems may be charged and/or discharged at the same rate or at different rates. In some embodiments, each stationary energy storage system may be discharged at a faster rate than it is charged.

The vehicle charging system may include any of the components, features, characteristics, or incorporate any of the steps involved with a vehicle, such as one described in U.S. Patent Publication No. 2010/0025132, which is hereby incorporated by reference in its entirety.

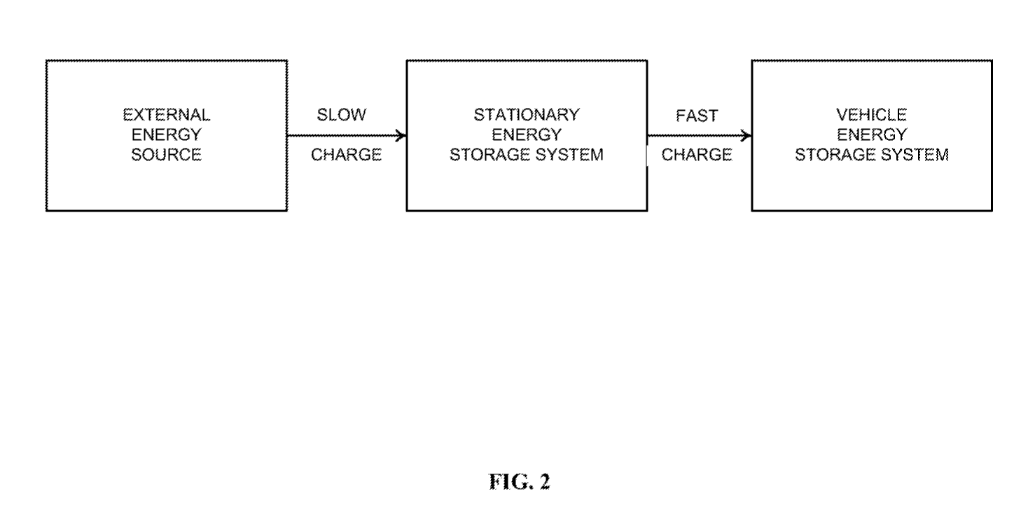

FIG. 2 provides a high level depiction of an energy transfer process. An external energy source may be in electrical communication with a stationary energy storage system. The stationary energy storage system may be electrical communication with a vehicle energy storage system. In a preferable embodiment, the external energy storage system may charge the stationary energy storage system at a slow rate while the stationary energy storage system may charge the vehicle energy storage system at a fast rate. In a preferable embodiment, the fast rate of charge may be higher than the slow rate of charge.

In preferable embodiments, the fast rate of charge may be about 30 kW or more, 50 kW or more, 60 kW or more, 80 kW or more, 100 kW or more, 120 kW or more, 150 kW or more, 200 kW or more, 300 kW or more, 500 kW or more, 1000 kW or more, 2000 kW or more, or 5000 kW or more. The slow rate of charge may be about 10 kW or less, 20 kW or less, 30 kW or less, 40 kW or less, 50 kW or less, 55 kW or less, 60 kW or less, 65 kW or less, 70 kW or less, 80 kW or less, 90 kW or less, 100 kW or less. Such charge rates may vary or remain steady during a charging process. In some embodiments, the stationary energy storage system may be charged at a first rate (R1) while the vehicle energy storage system may be charged by the stationary energy storage system at a second rate (R2). R2 may be greater than or equal to R1. Preferably R2 may be significantly higher than R1. For example, R2:R1may be about 1.5:1 or greater, 2:1 or greater, 3:1 or greater, 4:1 or greater, 5:1 or greater, 6:1 or greater, 8:1 or greater, 10:1 or greater, 15:1 or greater, 20:1 or greater, 25:1 or greater, 30:1 or greater, 50:1 or greater, 100:1 or greater, or 200:1 or greater.

Preferably, the slow charge and the fast charge may occur simultaneously. For example, when a vehicle is in contact with a charging station, the vehicle may be charged by the stationary energy storage system. At such times, the vehicle energy storage system may be charged by the stationary energy storage system while the stationary energy storage system is being charged (e.g., being charged at a lower rate) by an external energy source. In other embodiments, while the vehicle energy storage system is being charged, the stationary energy storage system need not be charged by the external energy source, or the rate of charge of the stationary energy storage system may be altered. The stationary energy storage system may be charged while a vehicle energy storage system is not being charged and/or while the vehicle energy storage system is being charged.

In some embodiments, a stationary energy storage system may spend more time being charged than a vehicle energy storage system. For example, the ratio of time spent for charging a stationary energy storage system to the time spent charging a vehicle energy storage system may be about 1.5:1 or greater, 2:1 or greater, 3:1 or greater, 4:1 or greater, 5:1 or greater, 6:1 or greater, 8:1 or greater, 10:1 or greater, 15:1 or greater, 20:1 or greater, 25:1 or greater, 30:1 or greater, 50:1 or greater, 100:1 or greater, or 200:1 or greater.

In some embodiments, the energy storage capacity for the stationary energy storage system may be greater than, equal to, or less than the energy storage capacity for the vehicle energy storage system. For example, the stationary energy storage system may store on the order of about 5 kWh or greater, 10 kWh or greater, 20 kWh or greater, 30 kWh or greater, 40 kWh or greater, 50 kWh or greater, 60 kWh or greater, 70 kWh or greater, 75 kWh or greater, 80 kWh or greater, 85 kWh or greater, 90 kWh or greater, 100 kWh or greater, 120 kWh or greater, 150 kWh or greater, 200 kWh or greater, 250 kWh or greater, 300 kWh or greater, or 500 kWh or greater. The vehicle energy storage system may store on the order of about 5 kWh or greater, 10 kWh or greater, 20 kWh or greater, 30 kWh or greater, 40 kWh or greater, 45 kWh or greater, 50 kWh or greater, 53 kWh or greater, 55 kWh or greater, 57 kWh or greater, 60 kWh or greater, 65 kWh or greater, 70 kWh or greater, 80 kWh or greater, 90 kWh or greater, 100 kWh or greater, 120 kWh or greater, 150 kWh or greater, 200 kWh or greater, or 250 kWh or greater. In some embodiments, the ratio of the energy storage capacity of the stationary energy storage system to the vehicle energy storage system may be about 100:1 or greater, 50:1 or greater, 30:1 or greater, 20: 1 or greater, 15:1 or greater, 10:1 or greater, 8:1 or greater, 7:1 or greater, 6:1 or greater, 5:1 or greater, 4.1 or greater, 3:1 or greater 2:1 or greater, 1.5 :1 or greater, 1.2:1 or greater, 1:1 or greater, 1:1.2 or greater, 1:1.5 or greater, 1:2 or greater, 1:3 or greater, 115 or greater, or 1:10 or greater.

Having a slower rate of charge for a stationary energy storage system and a faster rate of charge for the vehicle energy storage system may enable the current draw from the external energy source to be more even, while allowing a fast charge of a vehicle that may come into contact with the charging station. This may prevent strain on the external energy source, especially in situations where the external energy source may be limited. This may also provide cost-saving measures, when a rapid increase in energy draw from the external energy system may result in higher cost. This may also enable the control of when the stationary energy storage system draws energy from the external energy source depending on the cost at the time. For example, if the stationary energy storage system does not need to be charged immediately, it may wait to be charged at a time when costs for charging are lower, or when demands on the external energy source is less. Any features, components, or characteristics as known in the art may be incorporated by the invention. See, e.g., Patent Publication No. WO 2008/107767, Patent Publication No. US 2008/0277173, and Patent Publication No. WO 2009/014543, which are hereby incorporated by reference in their entirety.

In some embodiments, different rates of charge between a fast charge electrical interface and a slow charger may be provided by structural differences between the fast charge electrical interface and the slow charger. For example, a fast charger may be formed of a material with higher electrical conductivity than a slow charger, or may have a greater surface area of contact in an electrical connection. A fast charger may have less electrical resistance and/or impedance than a slow charger. In some instances, a fast charger may allow for stronger or firmer contact between electrically conductive surfaces. in another example, circuits may be configured differently between the fast charger and the slow charger to enable different charge rates. In other embodiments, the fast charger and the slow charger may have the same or similar configurations, but may be controlled by a controller to charge at different rates. In some embodiments, the rate of charge at a fast charger and/or slow charger may be controlled using pulse width modulation. For example, a faster rate of charge may be allowed to a fast charger by using pulse width modulation so that current is flowing the pulse is “on”) for more time than the charge provided in a slow charger. A fast charger may allow for charging at a higher rate than a slow charger based on structural differences, physical limitations of materials, and/or control of charge applied.

In some alternate embodiments, energy may be provided by the stationary energy storage system to the external energy source and/or energy may be provided by the vehicle energy storage system to the stationary energy storage system or external energy source. Thus, the stationary energy storage system may be discharged to a grid or vehicle energy storage system, or a vehicle energy storage system may be discharged to a grid or stationary energy storage system.

In some embodiments, the vehicle energy storage system may be provided on a vehicle. The vehicle energy storage system may be portable or travel with the vehicle. The stationary energy storage system may be provided at a charging station, or any other location upstream of the vehicle energy storage system. The external energy source may be a power grid. The stationary energy source may be provided downstream of the external energy source. The stationary energy storage system may be provided between the external energy source and the vehicle energy storage system.

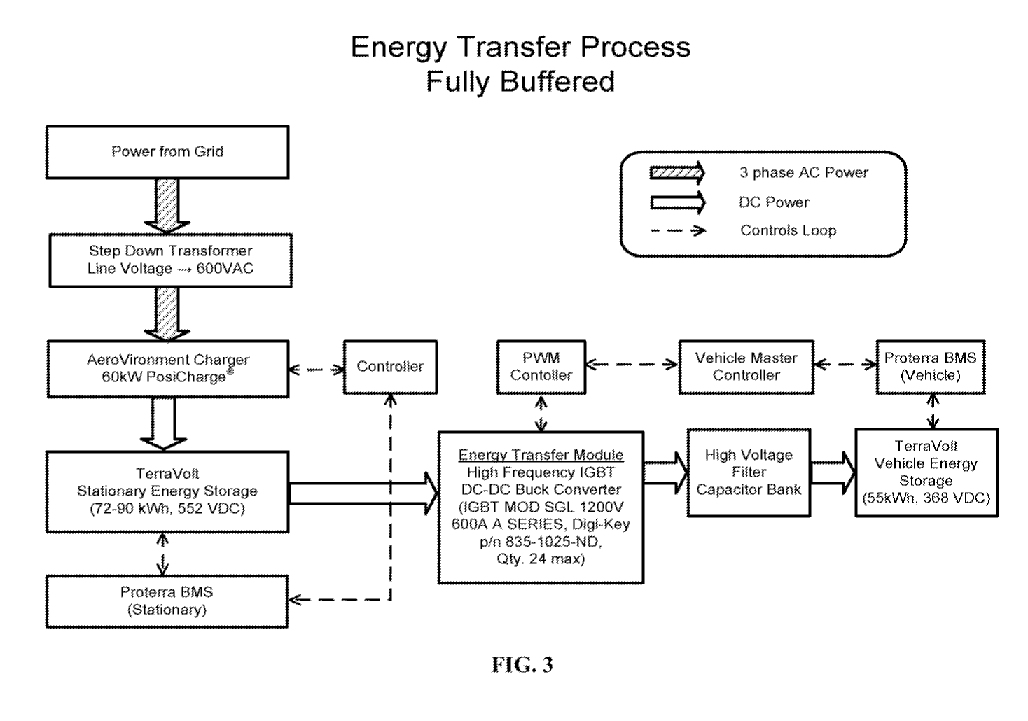

FIG. 3 shows an example of a fully buffered energy transfer process in accordance with an embodiment of the invention. Power may be provided by an external energy source, such as a grid. Such power may be 3 phase AC power. A step down transformer may convert the line voltage to a voltage that may be handled by the charging system (e.g., 600 VAC) This may include 3 phase AC power provided to a slower charger. The slow charger (e.g., AeroVironment Charter 60kW posicharge) may be used to charge the stationary energy storage system (e.g., TerraVolt stationary energy storage, 72-90 kWh. 552 VDC). The slow charger may convert AC power to DC power, and may provide DC power to the stationary energy storage system.

The stationary energy storage system may be in electrical communication with an energy transfer module. The energy transfer module may include a high frequency insulated-gate bipolar transistor (IGBT) and a DC-DC buck converter (e.g., IGBT MOD SGI, 1200V 600AA SERIES, Digi-Key pin 835-1025-ND, in some embodiments 24 or fewer). The energy transfer module may provide electricity to a high voltage filter capacitor bank. The capacitor hank may be used to smooth the output from the energy transfer module or tor some form of power factor correction. The capacitor bank may filter out undesirable voltages or fluctuations. The energy may then be transferred to a vehicle energy storage system (e.g., Terra Volt vehicle energy storage −55 Wh, 368 VDC).

In some embodiments, controls may be provided to one or more component of a vehicle charging system. For example, a controller may be in communication with a slow charger. A stationary battery management system (e.g., Proterra BMS-Stationary) may be in communication with the stationary energy storage system and the controller. The controller may control the slow charger (e.g., rate of charge, direction of charge, or whether charge occurs). The battery management system may determine the state of charge of the stationary energy storage system and/or communicate the state of charge to the controller. The battery management system and/or the controller may determine whether the charge rate of the stationary energy storage system needs to be varied or maintained.

A pulse width modulation (PWM) controller may be in communication with the energy transfer module. The PWM controller may control the energy transfer module (e.g., the rate of charge, direction of charge, or whether charge occurs). This may occur using PWM. A vehicle master controller may be in communication with the PWM controller. The vehicle master controller may provide signals to the PWM controller to determine the rate of charge and/or direction of charge, and the PWM controller may convert this to PWM. A vehicle battery management system (e.g., Proterra BMS-Vehicle) may be in communication with the vehicle energy storage system and vehicle master controller. The battery management system may determine the state of charge of the vehicle energy storage system and/or communicate the state of charge to the vehicle master controller. The battery management system and/or the vehicle master controller may determine whether the rate of charge of the vehicle energy storage system needs to be varied or maintained.

One implementation of the invention may specifically comprise a 60 kW charger which is connected to a lithium titanate, or other battery chemistry capable of a 6 C charge rate, and an energy storage module with 72-90 kWh capacity at approximately 552 VDC. A battery management system for the energy storage module would inform the charger controller when the state of charge has depleted below a certain level prompting the charger to continuously trickle charge the system at a rate of approximately 60 kW. When a vehicle arrives for a rapid recharge it connects with the charge arm of the charging station. The energy transfer module, in this case a high frequency IGBT driven DC-DC buck converter, transfers the energy from the stationary energy storage module to the vehicle mounted energy storage system. The energy transfer module is sized to pass at least 60 kW of energy in less than 10 minutes and is controlled by a PWM controller that is connected to the vehicle master controller which in turn is connected to the vehicle battery management system. In this implementation, the fast charge energy transfer process is fully buffered from the grid by the stationary energy storage system.

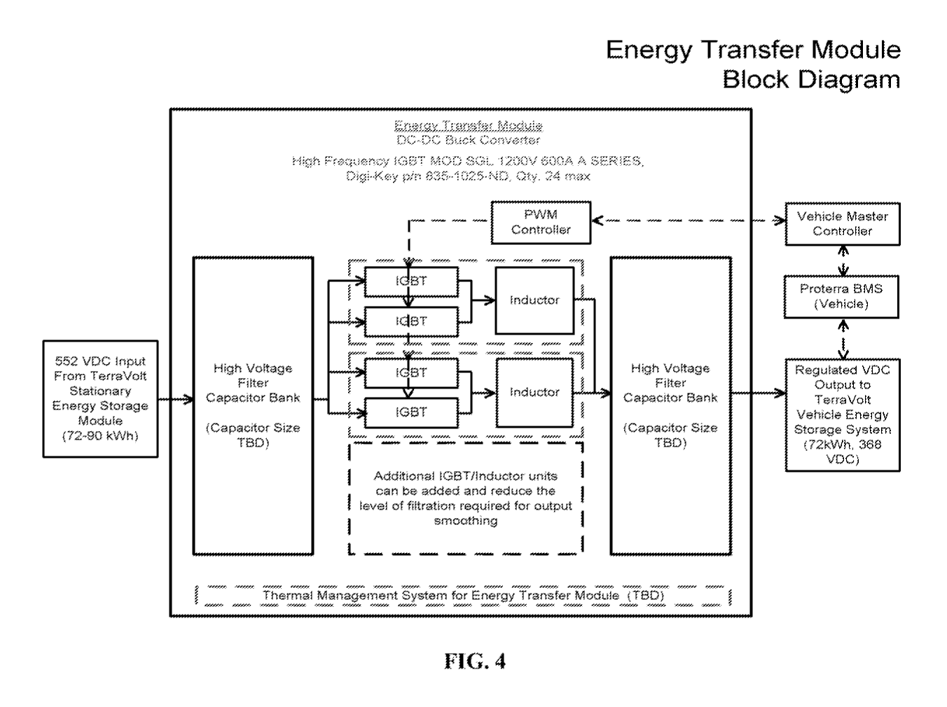

FIG. 4 is a block diagram of an energy transfer module. The energy transfer module may receive an energy input from a stationary energy storage system. In some embodiments, the input may be a 552 VDC input from a stationary energy storage module e.g., 72-90 kWh). The energy transfer module may provide energy to a vehicle energy storage system. In sonic embodiments, the energy may be a regulated VDC output to a vehicle energy storage system (72 kWh, 368 VDC).

The energy transfer module may include a DC-DC buck converter, high frequency IGBT MOD SGL 1200V 600AA series (or other IGBT) Digi-Key p/n 835-1025-ND (e.g., max 24 quantity). The energy transfer module may include one or more high voltage filter capacitor bank. In some embodiments, one or more capacitor bank may be provided to receive the energy input, and one or more capacitor bank may be provided before energy is output from the transfer module. The energy transfer module may also include one or more IGBT. The IGBTs may be connected in parallel. Alternatively, they may be connected in series or any combination of series or parallel. In some embodiments, one or more IGBTs may be electrically connected to one or more inductor. In some embodiments, two or more IGBTs may be electrically connected to an inductor. The inductors may convey energy to a capacitor bank, which may then output the energy. Any number of IGBTs and inductors may be provided. In some embodiments about 1 or more, 2 or more, 3 or more, 4 or more, 5 or more, 6 or more, 8 or more, 10 or more, 15 or more, 20 or more, 25 or more, 30 or more, 40 or more, 50 or more 1GBTs and/or inductors may be provided. In some embodiments, the ratio number of IGBTs to inductors may be 1:1, 2:1, 3:1, 4:1, 5:1, or more, or 1:1, 1:2. 1:5 or less. Having a larger number of IGBT/inductor units may be beneficial and may reduce the level of filtration required for output smoothing.

The energy transfer module may also include a PWM controller. The PWM controller may be able to communicate with one or more IGBTs. In some instances, the PWM controller may communicate with each IGBT individually and/or in parallel. Alternatively, the PWM controller may communicate with IGBTs in series, or may only communicate with one IGBT which may relay additional communications to other IGBTs. The PWM controller may be in communication with a vehicle master controller, which may be in communication with a vehicle battery management system, which may communicate with the vehicle energy storage system.

In some embodiments, an energy transfer module may also include a thermal management system for the energy transfer module. This may incorporate corporate the use of heat sinks, convection cooling, cooling fluids, or any other thermal management system known or later developed in the art.

Any of the figures herein may outline an overall process which may be packaged as a semi-portable trailer-skid mounted unit along with charging station components, which may be referred to as a Pod. Alternately, the Pod could be housed in a stationary permanent structure or building. The battery buffering of fast charge from the grid may be an advantageous feature.

FIG. 4 shows a proposed configuration for an IGBT based energy transfer module which could be also be an alternate DC-DC converter configuration. An IGBT based energy transfer module could also be utilized as a grid-tied inverter in place of the upstream charger. A preferable embodiment for energy storage may utilize lithium titanate due to its balanced high energy capacity and high specific power output. Alternately, the energy storage system could consist of a bank of ultra-capacitors, lithium iron phosphate cells, or other battery chemistries with 6 C or greater charge and discharge capability.

An IGBT DC-DC buck/boost converter may be used in synchronous rectification in the system. An IGBT configuration or configuration utilizing an IGBT may advantageously be used in power electronics. In some embodiments, high frequency IGBTs may be used in high power systems (e.g., with greater than 10 kW output). The use of high frequency IGBTs as a synchronous rectification bridge may enable zero threshold cross for low power loss for conversion to DC high power systems with greater than 10 kW. Preferably, the system will be about 500 kW. Other values may be provided.

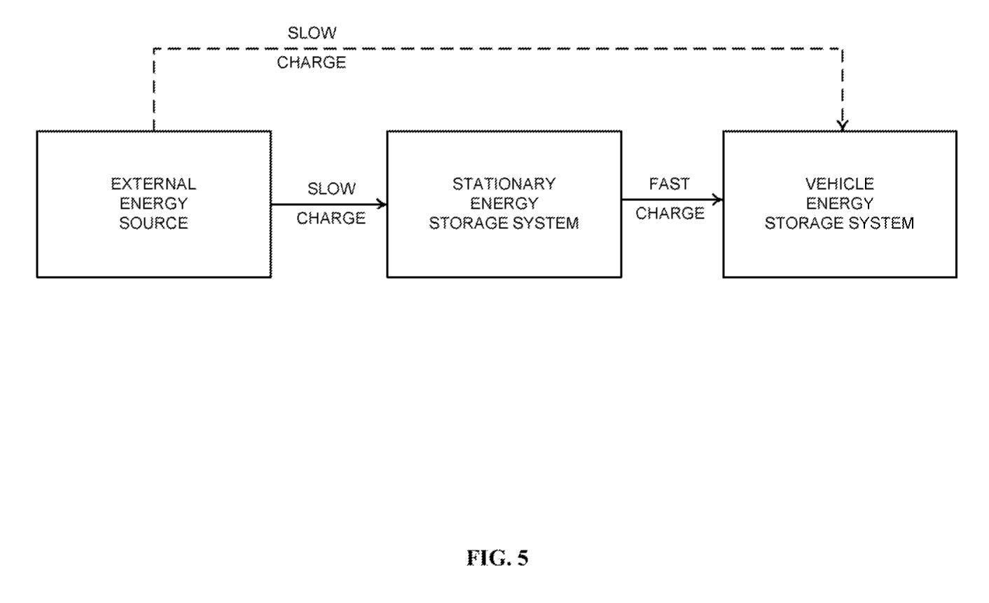

FIG. 5 provides a high level depiction of an energy transfer process, which may be partially buffered, in accordance with an embodiment of the invention. A partially buffered configuration could be utilized in which the stationary energy storage could be charged using the slow charger and then both the stationary energy storage and upstream slow charger could be simultaneously be used to charge the vehicle energy storage system. The advantage of this configuration could be a reduction in the size of the stationary energy storage system while maintaining the lower draw on the grid.

An external energy source may be in electrical communication with a stationary energy storage system. The stationary energy storage system may be electrical communication with a vehicle energy storage system. In a preferable embodiment, the external energy storage system may charge the stationary energy storage system at a slow rate while the stationary energy storage system may charge the vehicle energy storage system at a fast rate. In some embodiments, while the vehicle energy storage system is being charged, the external energy source may change the vehicle energy storage system. In preferable embodiments, the external energy source may do so at a slow rate of charge, while in alternate embodiments, it may have an increased rate of charge. In some instances, while charging the vehicle energy storage system, the external energy source may or may not be charging the stationary energy storage system simultaneously. in a preferable embodiment, the fast rate of charge may be higher than the slow rate of charge.

In preferable embodiments, the fast rate of charge may be about 500 kW. The slow rate of charge may be about 70 kW. Such charge rates may vary or remain steady during a charging process. in some embodiments, the stationary energy storage system may be charged at a first rate (R1) while the vehicle energy storage system may be charged by the stationary energy storage system at a second rate (R2). R2 may be greater than or equal to R1. Preferably R2 may be significantly higher than R1. For example, R2:R1 may be about 1.5:1 or greater, 2:1 or greater, 3:1 or greater, 4:1 or greater, 5:1 or greater, 6:1 or greater, 8:1 or greater, 10:1 or greater, 15:1 or greater, 20:1 or greater, 25:1 or greater, 30:1 or greater, 50:1 or greater, 100:1 or greater, or 200:1 or greater. In some embodiments, while the vehicle energy storage system is being charged, the external energy source may charge the vehicle energy storage system (either in addition to charging the stationary energy storage system or instead of charging the stationary energy storage system). If the external energy source is directly charging the vehicle energy storage system instead of the stationary energy storage system, the vehicle energy storage system may be charged at a rate of R1+R2. In some embodiments, the external energy source may rapidly charge the vehicle energy storage system, so that the vehicle energy storage system may be charged at a rate of R2+R2. Alternatively, it may be charged at any other rate.

In sonic alternate embodiments, the slow charge and the fast charge may occur simultaneously. For example. when a vehicle is in contact with a charging station, the vehicle may be charged by the stationary energy storage system. At such times, the vehicle energy storage system may be charged by the stationary energy storage system while the stationary energy storage system is being charged (e.g., being charged at a lower rate) by an external energy source. In other embodiments, while the vehicle energy storage system is being charged, the stationary energy storage system need not be charged by the external energy source, or the rate of charge of the stationary energy storage system may be altered. The stationary energy storage system may be charged while a vehicle energy storage system is not being charged and/or while the vehicle energy storage system is being charged.

In some embodiments, a stationary energy storage system may spend more time being charged than a vehicle energy storage system. For example, the ratio of time spent for charging a stationary energy storage system to the time spent charging a vehicle energy storage system may be about 1.5:1 or greater, 2:1 or greater, 3:1 or greater, 4:1 or greater, 5:1 or greater, 6:1 or greater, 8:1 or greater, 10:1 or greater, 15:1 or greater, 20:1 or greater, 25:1 or greater, 30:1 or greater, 50:1 or greater, 100:1 or greater, or 200:1 or greater.

In some embodiments, the energy storage capacity for the stationary energy storage system may be greater than, equal to, or less than the energy storage capacity for the vehicle energy storage system. For example, the stationary energy storage system may store on the order of about 5 kWh or greater, 10 kWh or greater, 20 kWh or greater, 30 kWh or greater, 40 kWh or greater, 50 kWh or greater, 60 kWh or greater, 70 kWh or greater, 75 kWh or greater, 80 kWh or greater, 85 kWh or greater, 90 kWh or greater, 100 kWh or greater, 120 kWh or greater, 150 kWh or greater, 200 kWh or greater, 250 kWh or greater, 300 kWh or greater, or 500 kWh or greater. The vehicle energy storage system may store on the order of about 5 kWh or greater, 10 kWh or greater, 20 kWh or greater, 30 kWh or greater, 40 kWh or greater, 45 kWh or greater, 50 kWh or greater, 53 kWh or greater, 55 kWh or greater, 57 kWh or greater, 60 kWh or greater, 65 kWh or greater, 70 kWh or greater, 80 kWh or greater, 90 kWh or greater, 100 kWh or greater, 120 kWh or greater, 150 kWh or greater, 200 kWh or greater, or 250 kWh or greater. In some embodiments, the ratio of the energy storage capacity of the stationary energy storage system to the vehicle energy storage system may be about 100:1 or greater, 50:1 or greater, 30:1 or greater, 20: 1 or greater, 15:1 or greater, 10:1 or greater, 8:1 or greater, 7:1 or greater, 6:1 or greater, 5:1 or greater, 4:! or greater, 3:1 or greater 2:1 or greater, 1.5:1 or greater, 1.2:1 or greater, 111 or greater, 1:1.2 or greater, 1:1.5 or greater, 1:2 or greater, 1:3 or greater, 1:5 or greater, or 1:10 or greater.

As previously discussed, having a slower rate of charge for a stationary energy storage system and a faster rate of charge for the vehicle energy storage system may enable the current draw from the external energy source to be more even, while allowing a fast charge of a vehicle that may come into contact with the charging station. This may prevent strain on the external energy source, especially in situations where the external energy source may be limited. This may also provide cost-saving measures, when a rapid increase in energy draw from the external energy system may result in higher cost. This may also enable the control of when the stationary energy storage system draws energy from the external energy source depending on the cost at the time. For example, if the stationary energy storage system does not need to be charged immediately, it may wait to be charged at a time when costs for charging are lower. By allowing the vehicle energy storage system to be simultaneously charged by the external energy source and the stationary energy storage system, the vehicle energy storage system may be rapidly charged. In sonic instances, this may result in a smaller capacity stationary energy storage system being used. In some instances, a low draw may still be provided in from the external energy source during vehicle charge, while in other embodiments, then may be a temporarily high draw from the external energy source, but for a shorter period of time.

In some alternate embodiments, energy may be provided by the stationary energy storage system to the external energy source and/or energy may be provided by the vehicle energy storage system to the stationary energy storage system or external energy source. Thus, the stationary energy storage system may be discharged to a grid or vehicle energy storage system, or a vehicle energy storage system may be discharged to a grid or stationary energy storage system.

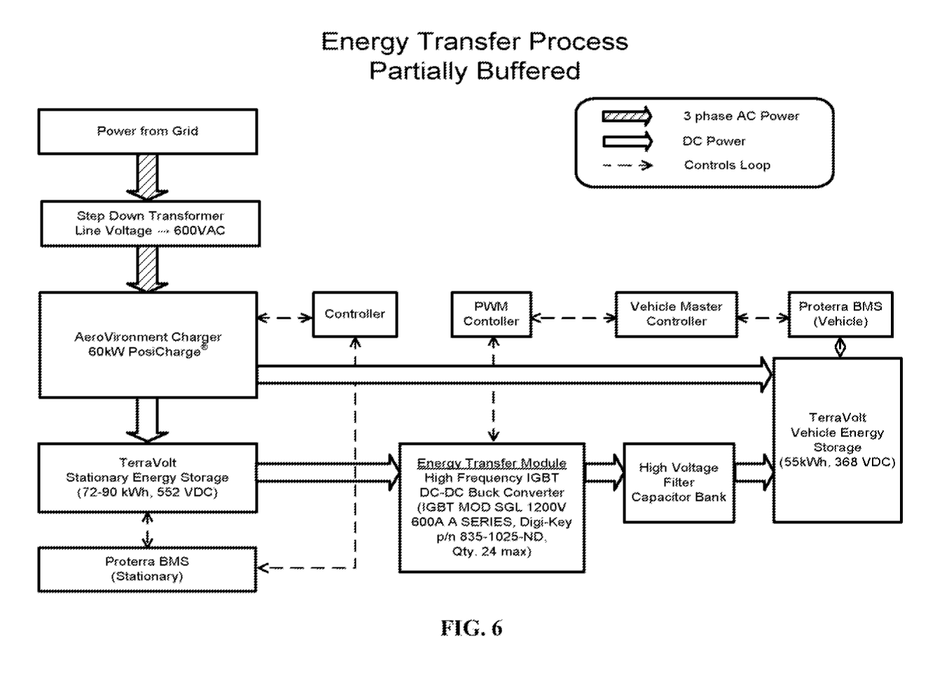

FIG. 6 shows an example of a partially buffered energy transfer process. A partially buffered energy transfer process may incorporate features or components of a fully buffered energy transfer process, such as one shown in FIG. 3. However, in a partially buffered energy transfer process, a slow charger (e.g., AeroVironment charger 60 kW PosiCharge), may provide energy from the grid directly to the vehicle energy storage system (e.g., Terra Volt vehicle energy storage—55 kWh, 368 VDC). In some embodiments, the energy transferred from the slow charger to the vehicle energy storage system may be DC power. In some embodiments, energy may simultaneously be transferred from the slower charger to the vehicle energy storage system and the stationary energy storage system. Alternatively, the slow charger may transfer energy to the vehicle energy storage system while the vehicle energy storage system is in electrical communication with the stationary energy storage system and not transfer energy to the stationary energy storage system.

Any other charging configurations may be employed in accordance with various embodiments of the invention. For example, a constant trickle, or charge sustaining configuration may be provided. A constant slow rate of charging may be provided to a stationary system. For example, 70 kW of constant charging may occur during all hours of operation. This may advantageously allow for the smallest stationary energy storage system,

Another example of a charging configuration may include a peak shaving configuration. A higher slow charge rate may occur during off peak hours, with a lower charge rate during peak hours. This may advantageously provide a cost effective solution when costs for charging during peak hours are higher than for charging during off peak hours. This may also moderate system demand so that a higher rate of charge is provided when there is less demand on the system, and a lower charge rate is provided when there is more demand on the system. In some embodiments, the peak and of peak hours may be predetermined, and the rate of charge may thus also be predetermined based on time. In other embodiments, the system may be able to measure or receive information about the load, and determine whether there is more or less demand on the system, and adjust charge rate accordingly.

Peak avoidance may be another example of a charging configuration A higher slow charge rate may occur during off peak times sufficient to completely stop charging during peak hours. This may require a larger stationary buffer than a peak shaving or constant trickle/charge sustaining configuration. For example, the energy storage system may only be charged during of peak times. As previously discussed, the peak times may or may not be predetermined ahead of time or sensed in real-time.

These charging scenarios may be applied against a representative demand rate schedule for varying fleet sizes of buses on a fixed route. A constant trickle may use the smallest stationary energy storage system of the configurations described. Full peak avoidance may require a significantly upsized stationary energy storage system. In order for full peak avoidance to be cost effective, off peak charge rates may be increased or go up. The demand schedule pricing for higher charge rates may have a mitigating effect of gains from shutting down during peak hours. Demand schedule pricing may vary over time, and a desired charging configuration may change accordingly.

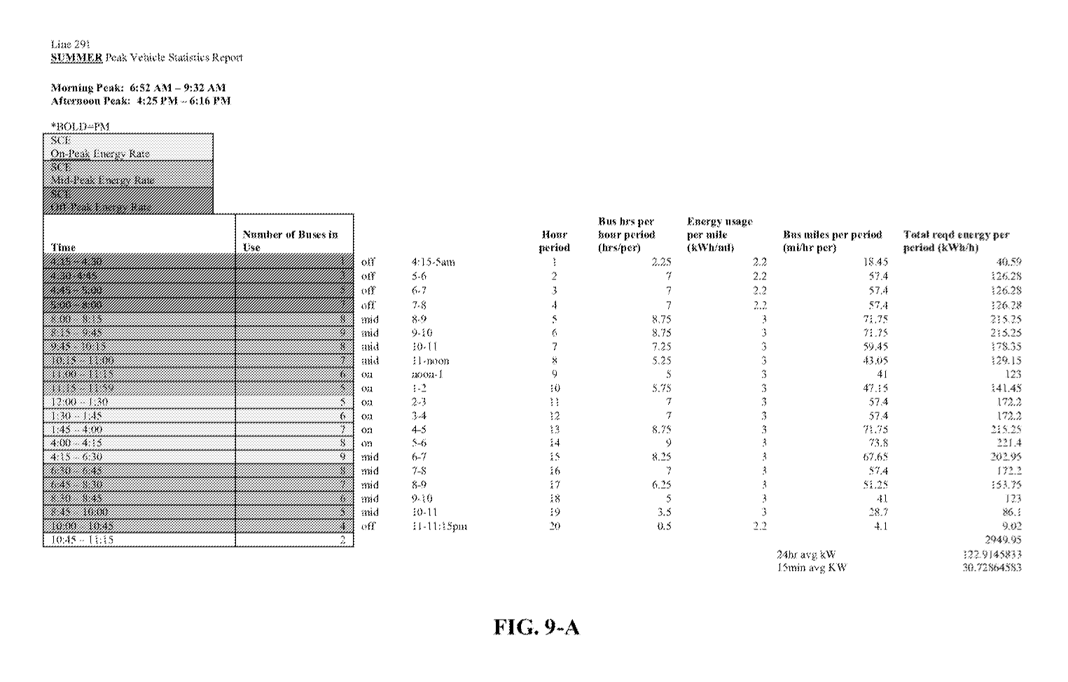

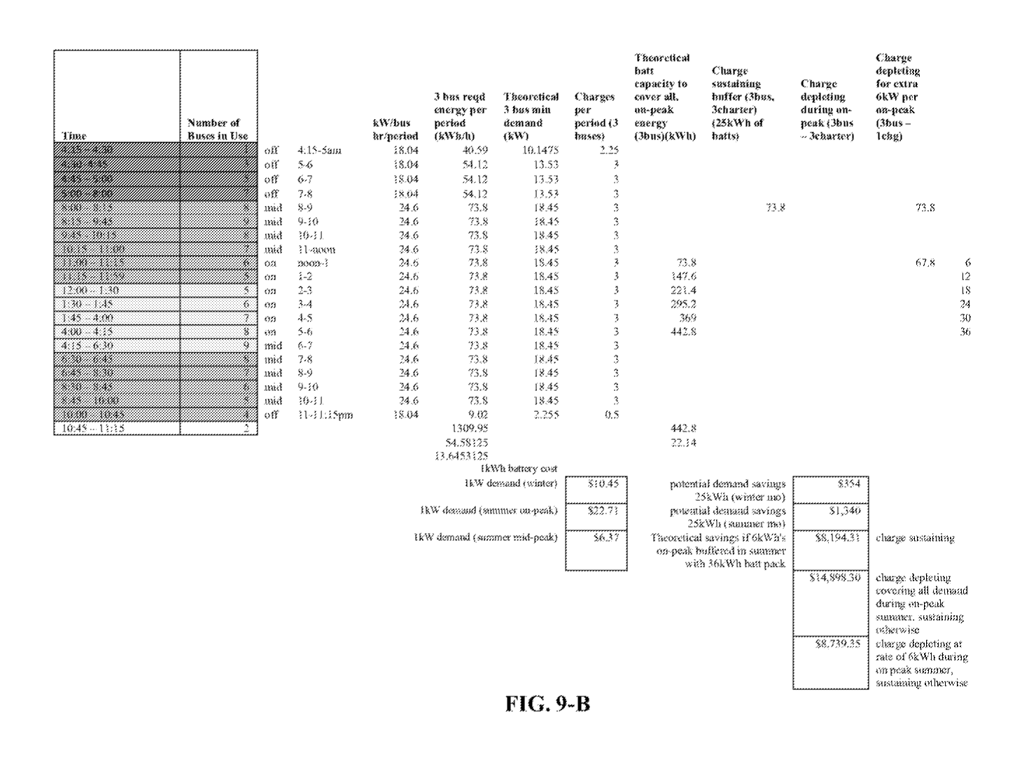

FIGS. 9A-B provides an example of a table showing an analysis during on-peak, mid-peak, and off-peak. Such values are provided by way of example only. Such values show an example of energy used and potential savings.

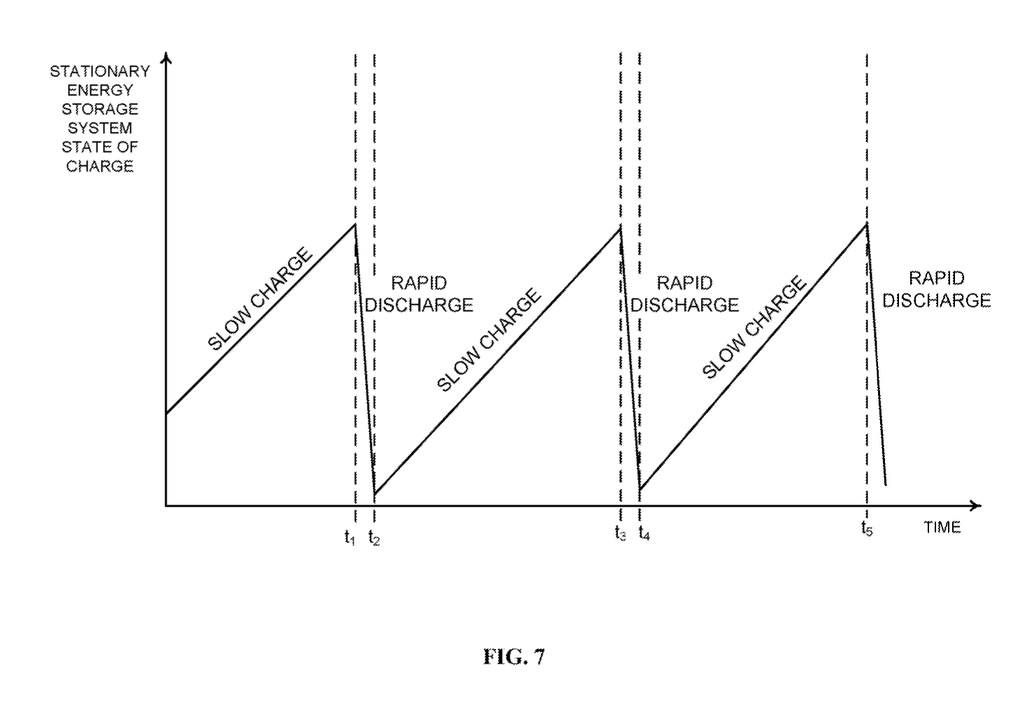

FIG. 7 shows an example of how a state of charge of a stationary energy storage system may vary over time. For example, over time, the stationary energy storage system may be slowly charged. Thus the state of charge of the stationary energy storage system may be gradually increased over time. When a vehicle makes electrical contact with a charging station, the vehicle energy storage system may be charged by the stationary energy storage system. Thus, the stationary energy storage system may be discharged while the vehicle energy storage system is being charged. In some embodiments, a rapid discharge may occur at the stationary energy storage system while charging the vehicle energy storage system.

For example, as shown, between times t₁ and t₂, a vehicle energy storage system may be charged by the stationary energy storage system. The steepness of the change in the state of charge may be greater during discharge than during the slow charge. Thus, the stationary energy storage system discharge rate may be greater than the charge rate. This may indicate that the stationary energy storage system is being discharged more rapidly than it is being charged. In some embodiments, the amount of time for discharge may be less than the amount of time for charging (e.g., the difference in time between t₁ and t₂ may be less than the difference in time between t₂ and t₃).

In some embodiments, the discharge may occur at relatively regular intervals. For example, a vehicle may be traveling along a fixed route and may return to the charging station at substantially regular intervals. In other embodiments, the gaps of times between vehicles that may arrive at a charging station may be somewhat regular. Alternatively, the amounts of time when vehicles arrive at the charging station may vary and/or be irregular. In some embodiments, the total amount of discharge from the stationary energy storage system may vary depending on the state of charge of a vehicle energy storage system.

Although straight lines are shown to indicate charge and discharge, the lines need not be straight, and may curve, fluctuate, or bend in any other manner. The state of charge may vary in any manner.

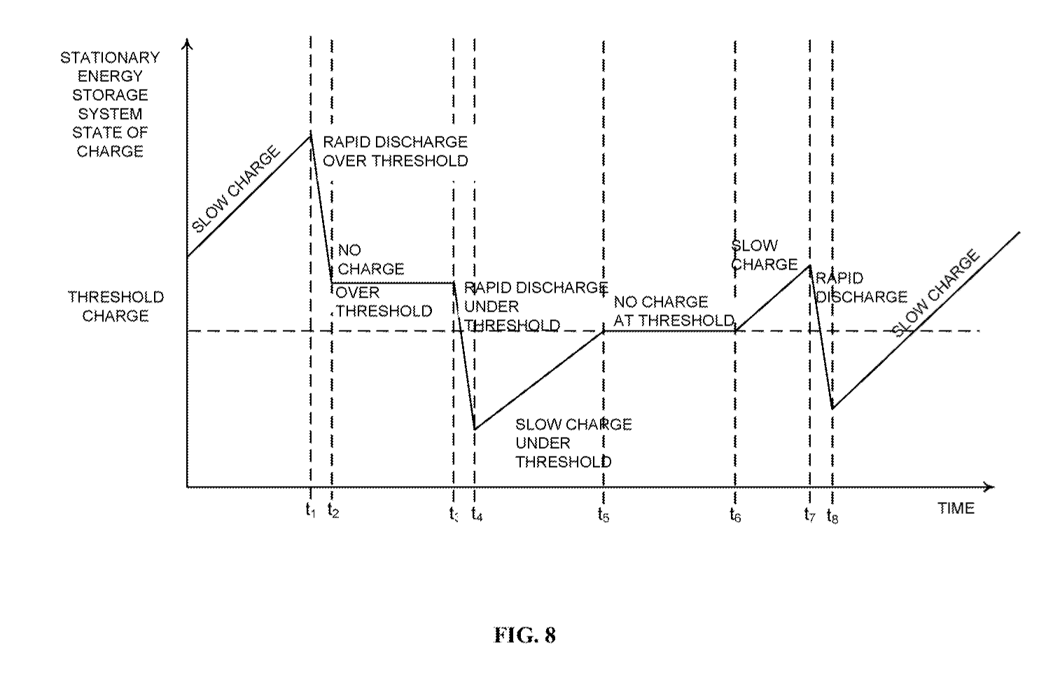

FIG. 8 shows an additional example of how a state of charge of a stationary energy storage system may vary over time. For example, a stationary energy storage system may slowly be charged by an external energy source. Then at t₁, a vehicle energy storage system may be charged, causing the stationary energy storage system to be discharged rapidly. The stationary energy storage system may be discharged more rapidly than it is charged the external energy source.

In some embodiments, a threshold charge value may be provided for the stationary energy storage system. The threshold charge value may be a state charge for which is it may be desired for the stationary energy storage system to remain over. For example, if the state of charge is above a threshold state of charge, the stationary energy storage system need not be charged. If the state of charge falls below the threshold state of charge, the stationary energy storage system may be charged. In some embodiments, the stationary energy storage system may be charged so as to not greatly exceed the threshold state of charge. Alternatively in some embodiments, if a stationary energy storage system falls below a threshold charge, the stationary energy storage system may be fully charged. Whether a stationary energy storage system is charged or not over the threshold value may depend on an algorithm or control process. In some instances, the algorithm or control process may depend on the external energy source (e.g., pricing for using external energy source power to charge). In some embodiments, a threshold charge value may be predetermined, or set when manufactured. Alternatively, the threshold charge value may be set or modified by a user, or automatically selected by a control process or algorithm. Any action taken by the control process or algorithm may be directed by tangible computer readable media, code, instructions, or logic thereof. For example, computer code may be provided that may execute any of the steps provided in a vehicle charging system. These may be stored in a memory, such as the memory of a battery management system, controller, computer, or any other component of a vehicle charging system, which may be internal or external to a charging station or vehicle.

In one instance, a discharge of the stationary energy storage system may leave the state of charge still over the threshold charge value. For example, at t₂, when the stationary energy storage system has been discharged, the state of charge may remain over the threshold charge value. in some instances if the stationary energy storage system is over the threshold charge value it may remain uncharged. Then, at t₃, a vehicle energy storage system may be charged, which may cause the stationary energy storage system to be discharged. Once the stationary energy storage system has been discharged, at t₄, it may have fallen below the threshold charge value.

The stationary energy storage system may then be charged to reach the minimal threshold value. In some embodiments, once the state of charge has reached the threshold, the system may determine, using some sort of algorithm or control protocol, whether further charging is desirable. For example, at t₅, the threshold state of charge may have been reached. In one instance, it may be determined that further charging at that time may not be desirable (e.g., price for pulling electricity from the grid may be high, or overall demand on the utility system may be too high at that time), so no charging may occur. At some subsequent time t₆, it may be determined that desirable charging conditions have occurred (e.g., price for charging has dropped, or the system is no longer overloaded). In such a case, the stationary energy storage system may be charged.

At some subsequent time t₇, the stationary energy storage system may be discharged again to charge a vehicle energy storage system. Once the charging has been completed (t₈), and if the state of charge falls below the threshold, the stationary energy storage system may be charged. In some embodiments, if charging conditions are considered to be favorable, the stationary energy storage system may be charged even it exceeds the threshold.

In some embodiments, a state of charge controlling algorithm or protocol may be determined by a battery management system or a controller. For example, the stationary energy storage system state of charge may be managed by the stationary battery management system. In some embodiments, the state of charge of a vehicle energy storage system may also be managed in a similar manner. The vehicle energy storage system may be managed by a vehicle battery management system. Alternatively, an external controller or battery management system may be used to manage state of charge. For example, a protocol, algorithm, or any other set of instructions may be provided to a stationary battery management system or vehicle battery management system from an external control source. Alternatively, the external control source may communicate directly with a stationary controller or vehicle master controller.

Although straight lines are shown to indicate charge and discharge, the lines need not be straight, and may curve, fluctuate, or bend in any other manner. Similarly, any set of rules may be applied, which may result in the state of charge varying in any manner determined by the control rules. In preferable embodiments, a stationary energy storage system may be slowly charged by an external energy source and may rapidly discharge to charge a vehicle energy storage system. In alternate embodiments, the rate of charge and discharge may vary. In one example, the stationary energy storage system may be charged by the vehicle energy storage system and may discharge to provide energy to an external energy source. In such situations, the stationary energy storage system may be rapidly charged by the vehicle energy storage system, and may discharge rapidly or slowly to provide energy to the external energy source.

An ideal application of the vehicle charging system would involve a transit bus application on a fixed route. Other applications could involve school buses, delivery trucks or garbage trucks operating on a fixed route. A portable charging station could be placed on route. The charger could continuously replenish the stationary energy storage system at a rate of 60 kW. A typical transit bus may average 11-13 mph. An exemplary battery electric bus may use 2.2 kWh/mile or no more than 29 kWh per hour. If the bus repeats its route every hour and passes under the charge station it can be fast charged from the energy storage pod in approximately 5 minutes without adversely affecting the grid. In this configuration, one or even two fast charge battery electric buses could be fast charged per hour in a residential or power limited area from a slow charge source without adversely affecting the gird due to high power draw.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A charging station comprising:
a fast charging interface for electrically connecting with and charging a vehicle energy storage system;
a stationary energy storage system electrically connected to the fast charging interface, and
a slow charger in electrical communication with an external energy source and the stationary energy storage system, wherein the slow charger permits a lower charge rate of the stationary energy storage system from the external energy source than the fast charging interface permits for charging the vehicle energy storage system from the stationary energy source.

2. The charging station of claim 1, wherein the slow charger is also configured to electrically connect the external energy source with the vehicle energy storage system.

3. The charging station of claim 1, wherein the external energy source is a utility or grid.

4. The charging station of claim further comprising a charging station controller that selectively controls the slow charger to permit charging of the stationary energy storage system.

5. The charging station of claim 4, wherein the controller controls the rate of charging of the stationary energy storage system.

6. A method for charging an electric vehicle comprising:
electrically connecting a stationary energy storage system at a charging station with an external energy source;
charging the stationary energy storage system at first rate;
electrically connecting a vehicle energy storage system on a vehicle with the stationary energy storage system; and
charging the vehicle energy storage system at a second rate that is greater than the first rate.

7. The method of claim 6 wherein charging the vehicle energy storage system occurs through a fast charging interface electrically connecting the vehicle energy storage system to the stationary energy storage system alone.

8. The method of claim 6 wherein charging the vehicle energy storage system occurs through a fast charging interface electrically connecting the vehicle energy storage system to the stationary energy storage system and through a slow rate charger electrically connecting the vehicle energy storage system to the external energy source.

9. The method of claim 6 wherein a slow rate charger electrically connects the external energy source to the stationary energy storage system or vehicle energy storage system by connecting to the external energy source via a conventional power receptacle.

10. The method of claim 6 further comprising determining the state of charge of the stationary energy storage system.

11. The method of claim 10 further comprising charging the stationary energy storage system if the state of charge of the stationary energy storage system is below a threshold charge.

12. A system for charging an electric vehicle comprising:
a vehicle with a vehicle energy storage system;
a charging station with:
a fast charging interface configured to be electrically connected with the vehicle energy storage system;
a stationary energy storage system configured to be electrically connected to the fast charging interface, thereby permitting electrical energy transfer between the stationary energy storage system and the vehicle energy storage system at a first rate;
an external energy source configured to electrically connect to the stationary energy storage system and permit electrical energy transfer at a second rate, wherein the first rate is greater than the second rate.

13. The system of claim 12 wherein the electrical energy transfer between the stationary energy storage system and the vehicle energy storage system is charging the vehicle energy storage system; and wherein the electrical energy transfer between the external energy source and the stationary energy storage system is charging the stationary energy storage. system.

14. The system of claim 12 wherein the electrical energy transfer between the stationary energy storage system and the vehicle energy storage system is discharging the vehicle energy storage system; and wherein the electrical energy transfer between the external energy source and the stationary energy storage system is discharging the stationary energy storage system.

15. The system of claim 12 wherein the external energy source is at least one of the following: utility, grid, or renewable energy source.

16. The system of claim 12 wherein the external energy source is in electrical communication with the vehicle energy storage system, thereby permitting electrical energy transfer between the external energy source and the vehicle energy storage system.

17. The system of claim 12 wherein the fast charging interface hang over the vehicle.
